(19) United States
(12) Patent Application Publication
(10) Pub. No.: US 2024/0190170 A1
(43) Pub. Date: Jun. 13, 2024

(54) BICYCLE WHEEL

(71) Applicant: DRAG2ZERO LTD, Silverstone, Northamptonshire (GB)

(72) Inventor: Simon SMART, Silverstone (GB)

(73) Assignee: DRAG2ZERO LTD, Silverstone, Northamptonshire (GB)

(21) Appl. No.: 18/285,236

(22) PCT Filed: Mar. 31, 2022
(86) PCT No.: PCT/GB2022/050824

§ 371 Date: Sep. 29, 2023

(30) Foreign Application Priority Data
Apr. 1, 2021 (GB) 2104719.6

(51) Int. Cl. B60B 21/06; B60B 21/12

(52) U.S. Cl. CPC B60B 21/062; B60B 21/12; B60B 2900/1216

(57) ABSTRACT

A bicycle wheel comprising an annular rim having an inner circumferential portion, an outer circumferential portion and a pair of side portions that extend between the inner circumferential portion and the outer circumferential portion. Each side portion comprises a primary surface and a plurality of pockets that are recessed below the primary surface.

The present invention relates a bicycle wheel.

For cyclists engaged in competitive cycling, aerodynamic drag is an important consideration that significantly affects performance. Considerable efforts have been made over the years to reduce the aerodynamic drag of both the cyclist and the bicycle, for example by making changes to the cyclist's gear and clothing and to the design of the bicycle.

One area that has received attention concerns the design of the bicycle wheels. Traditional bicycle wheels as commonly found on recreational bicycles typically have a square or rectangular cross-sectional profile and a short radial rim depth, for example about 20 mm. Such wheels do not provide an opportunity to control the flow of air around the tyre and the wheel rim, resulting in significant aerodynamic drag.

By increasing the radial rim depth it is possible to modify the shape of the rim to control the flow of air around the tyre and the rim and reduce aerodynamic drag. Significant gains can be achieved by increasing the rim depth to more than 35 mm, and many riders use a rim depth of 40-60 mm for road racing on rolling terrain. In time trials, triathlons and fast prologues riders may maximise the aerodynamic advantage with deeper sections, for example with a radial rim depth up to 80 mm.

When used on the front wheel, rim depths greater than 80 mm tend to be too sensitive to wind gusts and can be dangerous on open roads. A rim depth greater than 80 mm can however be used on the rear wheel.

For ultimate performance, solid disc wheels can be used. For indoor events where there are no side winds disc wheels can be used on the front and the rear wheels. For outdoor competitions the use of disc wheels is limited by the governing body to the rear wheel only for safety reasons.

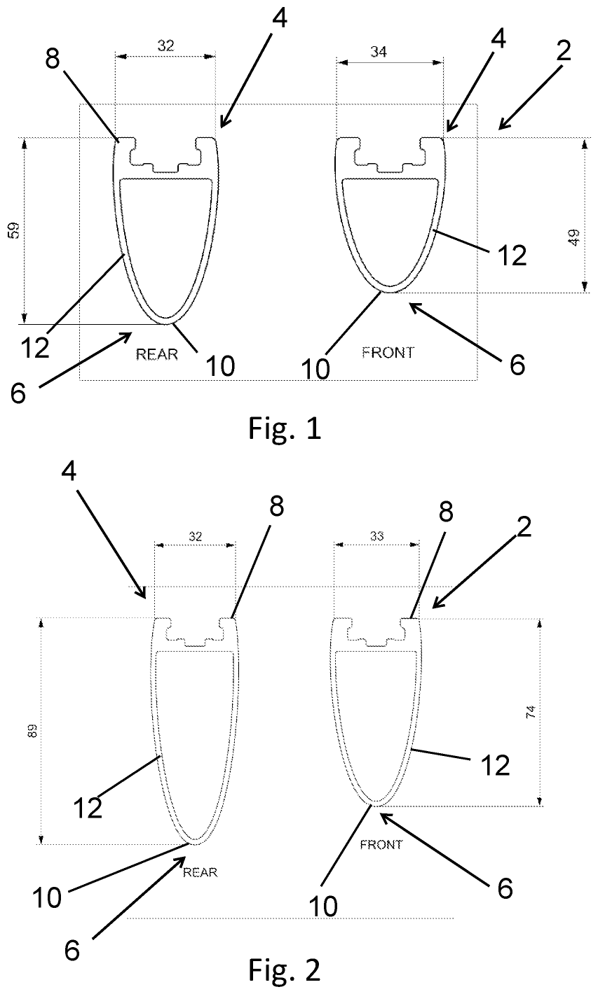

There have been significant developments in rim shape design over the last few years with various patents from Zipp, Hed and Enve relating to the curvature and the cross-sectional shape of the rims. Rim shapes have evolved from a V shape to a U shape and have settled at what has been described as a U-V shape. The cross-sectional rim shapes of some known aerodynamic wheel sets are illustrated in FIGS. 1 and 2, where FIG. 1 shows the front and rear wheels of a mid-depth aerodynamic wheel set and FIG. 2 shows the front and rear wheels of a deep aerodynamic wheel set.

In most bicycle wheels, the cross-section of the rim is substantially uniform. In other words, the rim comprises a volume of revolution from a 2D shape. However, rims with a non-uniform cross-section are also known. For example, in a wheel design by Mavic Kysrium dating from around 2002 undulations are provided on the inner circumference of the wheel rim, which is known as the spoke face. The design of this wheel rim was intended for improved mechanical efficiency.

The aerodynamic shapes of the wheel rims are tuned to minimise aerodynamic drag and provide stability in windy conditions. Ultimately, there is a compromise between minimising aerodynamic drag and providing sufficient stability for the wheel to ensure that the bicycle is stable and rideable on windy days. One of the main causes of instability is the non-linear change in forces acting on the wheel when the airflow around the wheel becomes separated. An important aspect of the invention therefore concerns reducing aerodynamic drag while also delaying the separation of the airflow when cross winds are present.

Various attempts have been made to address this problem.

Around 2001 Zipp patented the addition of dimples to the side surface of the rim. The dimples are very small (for example 1 mm or 2 mm in diameter) and they are moulded into the side surface of the rim. The dimples are intended to reduce drag and improve flow attachment in windy conditions.

Around 2017, Dimitris Katsanis filed a patent for a wheel rim with a saw tooth design for the spoke face, which was intended to improve stability and reduce drag. Wheels with a saw tooth spoke face are currently manufactured by Zipp and Princeton.

It is an object of the present invention to provide a bicycle wheel that mitigates at least some of the afore-mentioned problems.

According to one aspect of the present invention there is provided a bicycle wheel as defined by the claims.

According to one embodiment, there is provided a bicycle wheel comprising an annular rim having an inner circumferential portion, an outer circumferential portion and a pair of side portions that extend between the inner circumferential portion and the outer circumferential portion. Optionally, each side portion comprises a primary surface that forms the outermost surface of the rim and a plurality of pockets that are recessed below the primary surface.

We have found that by providing relatively large recessed pockets in the side portions of the rim, the air flow over the wheel can be turbulated (that is, turbulence can be generated), which helps to prevent separation of the air flow from the wheel. This means that separation is delayed and occurs only at larger yaw angles. As a result, aerodynamic drag can be reduced, particularly as the yaw angle increases, and the stability of the wheel can be increased, providing greater safety, comfort and rider confidence. These advantages provide a noticeable improvement over existing wheel designs using, for example, small dimples in the side portions of the rim.

According to another embodiment, there is provided a bicycle wheel comprising an annular rim having an inner circumferential portion, an outer circumferential portion and a pair of side portions that extend between the inner circumferential portion and the outer circumferential portion, wherein each side portion comprises a primary surface that forms the outermost surface of the rim and a plurality of pockets that are recessed below the primary surface, and wherein each of the pockets extends across the inner circumferential portion and then extends outwards across the side portions of the rim.

In one embodiment, the bicycle wheel further comprises a hub and a plurality of connecting elements that connect to the annular rim to the hub. The inner circumferential portion may for example comprise a spoke face that is connected via spokes or other connecting elements (for example blades) to a wheel axle or hub located at the rotational axis of the wheel. Alternatively, the inner circumferential portion may be configured to contact the wheel axle directly, whereby the bicycle wheel comprises a solid disc.

The outer circumferential portion may comprise a mounting portion for receiving a tyre and may include mounting elements, for example flanges for mounting a conventional clincher type tubed tyre, or a mounting surface for tubeless tyres.

The side portions may for example comprise side walls if the rim is hollow, or side surfaces if the rim is solid. The side portions may be flat or curved and they may be parallel to one another or they may converge towards one another in the inwards radial direction. The inner circumferential portion may comprise an element that is connected to the side portions but distinguishable therefrom, or it may comprise a continuation of the side portions which connects the side portions to one another.

Optionally, each side portion comprises a primary surface, which constitutes a laterally outermost surface of the side portion, and a plurality of pockets that are recessed below the primary surface, for example inwards towards the plane of the wheel (where the plane of the wheel is perpendicular to the axis of rotation of the wheel).

Optionally, each pocket has an area S of at least 0.25 cm², preferably at least 1 cm², preferably at least 2 cm², preferably at least 5 cm², preferably at least 10 cm². For example, for a rim with a radial rim depth of 50 mm each pocket may typically have an area of about 10-20 cm², whereas for a rim with a radial rim depth of 80 mm each pocket may typically have an area of about 15-30 cm². For disc wheels the area of each pocket may be even larger. Pockets with areas at the smaller end of this range may for example consist of narrow lines, for example such a line pocket could have a width of 0.1 cm and a length of 2.5 cm, giving an area of 0.25 cm². However, other shapes and dimensions are of course possible.

Optionally, each pocket has an area S of less than 50 cm², preferably less than 40 cm², preferably less than 30 cm². However, for disc wheels the area of each pocket may be larger than the values indicated above.

Optionally, each pocket has a recess depth R greater than 0.1 mm, preferably greater than 0.2 mm, preferably greater than 0.4 mm, preferably greater than 0.6 mm.

Optionally, each pocket has a recess depth R less than 4 mm, preferably less than 2 mm, preferably less than 1 mm.

The recess depth of the pocket is measured relative to the primary surface of the rim in a direction that is perpendicular to the plane of the wheel. Typically, for example, each pocket may have a recess depth in the range 0.4 mm to 2.0 mm, preferably 0.5 mm to 1.0 mm.

Optionally, each pocket comprises a base portion and at least one side wall that extends between the base portion and the primary surface.

Optionally, the at least one side wall is inclined relative to the primary surface at an angle in the range 5-30 degrees, preferably 8-20 degrees, preferably 10-15 degrees.

Optionally, the pockets extend substantially radially. In other words, the pockets extend outwards in a direction from the centre of the wheel towards the outer circumference of the wheel. Rotation of the wheel then causes the air to flow into and out of the pockets as the bicycle moves forwards generating a turbulent airflow.

Optionally, each pocket includes a base portion and a pair of side walls that extend between the base portion and the primary surface, wherein each side wall extends at an angle A relative to a radial direction, where the angle A is in the range 0-30 degrees, preferable 10-30 degrees, preferably 15-25 degrees. Air flow over the side walls of the pockets again leads to a turbulent airflow.

Optionally, the said pair of side walls converge towards one another in a radially outward direction. That is, the side walls on the opposite sides of each pocket are closer together at the outer end of the pocket than they are at the inner end of the pocket. Alternatively, the side walls may be parallel or diverge away from one another in a radially outward direction. The side walls may be straight or curved. The pockets may also have various other shapes, for example they may be round, oval, polygonal or a mixture of those and other shapes.

Optionally, each of the pockets extends across the inner circumferential portion and then extends outwards across the side portions of the rim. We have found that providing pockets that extend continuously across the inner circumferential portion and the side portions of the rim is particularly advantageous and helps to prevent separation of the air flow from the wheel. As a result, aerodynamic drag can be reduced, particularly as the yaw angle increases, and the stability of the wheel can be increased, providing greater safety, comfort and rider confidence.

Alternatively, separate pockets may be provided on each of the side portions. Optionally, the pockets may be omitted from the inner circumferential portion of the rim.

Optionally, the rim has a rim depth D measured radially between the inner circumferential portion and the outer circumferential portion, and each pocket extends radially for a pocket radial distance P, where P has a value of at least 0.4D, preferably at least 0.6D, preferably at least 0.8D. For example, if the rim has a rim depth D of 50 mm, each pocket may extend radially for a pocket radial distance P of at least 20 mm, preferably at least 30 mm, preferably at least 40 mm. If the rim has a rim depth D of 80 mm, each pocket may extend radially for a pocket radial distance P of at least 32 mm, preferably at least 48 mm, preferably at least 64 mm.

Optionally, each side portion includes a number N of pockets spaced circumferentially around the rim, where the number N is in the range 8-50, preferably 10-40, preferably 15-36. The pockets may be evenly spaced around the circumference of the rim or unevenly spaced.

Optionally, each side portion of the wheel rim includes a plurality of pockets spaced circumferentially around the rim, wherein each pocket is spaced from an adjacent pocket by a spacing angle B in the range 7-45 degrees, preferably 12-36 degrees, preferably 15-24 degrees.

Optionally, the rim has a rim depth D measured radially between the inner circumferential portion and the outer circumferential portion, wherein the rim depth D is in the range 30-200 mm, preferably 40-100 mm, preferably 50-80 mm.

Optionally, the rim has a cross-sectional profile that is substantially U shaped, or substantially V shaped, or U-V shaped.

Optionally, the inner circumferential portion may contact an axle or hub of the wheel, whereby the bicycle wheel comprises a disc wheel.

According to another embodiment of the invention there is provided a bicycle wheel comprising a disc having an axis of rotation, an outer circumferential portion and a pair of side portions that extend between the axis of rotation and the outer circumferential portion, wherein each side portion comprises a primary surface and a plurality of pockets that are recessed below the primary surface. In this embodiment, the wheel comprises a disc wheel.

Optionally, each pocket has an area S of at least 1 cm², preferably at least 2 cm², preferably at least 5 cm², preferably at least 10 cm².

Optionally, each pocket has an area S of less than 50 cm², preferably less than 40 cm², preferably less than 30 cm².

Optionally, each pocket has a recess depth R greater than 0.1 mm, preferably greater than 0.2 mm, preferably greater than 0.4 mm, preferably greater than 0.6 mm.

Optionally, each pocket has a recess depth R less than 4 mm, preferably less than 2 mm, preferably less than 1 mm.

Optionally, each pocket comprises a base portion and at least one side wall that extends between the base portion and the primary surface.

Optionally, the at least one side wall is inclined relative to the primary surface at an angle in the range 5-30 degrees, preferably 8-20 degrees, preferably 10-15 degrees.

Optionally, the pockets extend substantially radially.

Optionally, each pocket includes a base portion and a pair of side walls that extend between the base portion and the primary surface, wherein each side wall extends at an angle A relative to a radial direction, where the angle A is in the range 0-30 degrees, preferable 10-30 degrees, preferably 15-25 degrees.

Optionally, said pair of side walls converge in a radially outward direction.

Optionally, each side portion includes a number N of pockets spaced circumferentially around the rim, where the number N is in the range 8-50, preferably 10-30, preferably 15-25.

Optionally, each side portion includes a plurality of pockets that are spaced circumferentially around the rim, wherein each pocket is spaced from an adjacent pocket by a spacing angle B in the range 7-45 degrees, preferably 12-36 degrees, preferably 15-24 degrees.

Optionally, the wheel has a wheel radius W measured radially between the axis of rotation and the outer circumferential portion, and each pocket is located in a radially outer part of the wheel at a distance X from the axis of rotation, where X is at least 0.4W, preferably at least 0.6W, preferably at least 0.8W.

Certain embodiments of the present invention will now be described, by way of example, with reference to the accompanying drawings, in which:

FIG. 1 is a cross-section through the wheel rims of a first conventional wheel set;

FIG. 2 is a cross-section through the wheel rims of a second conventional wheel set;

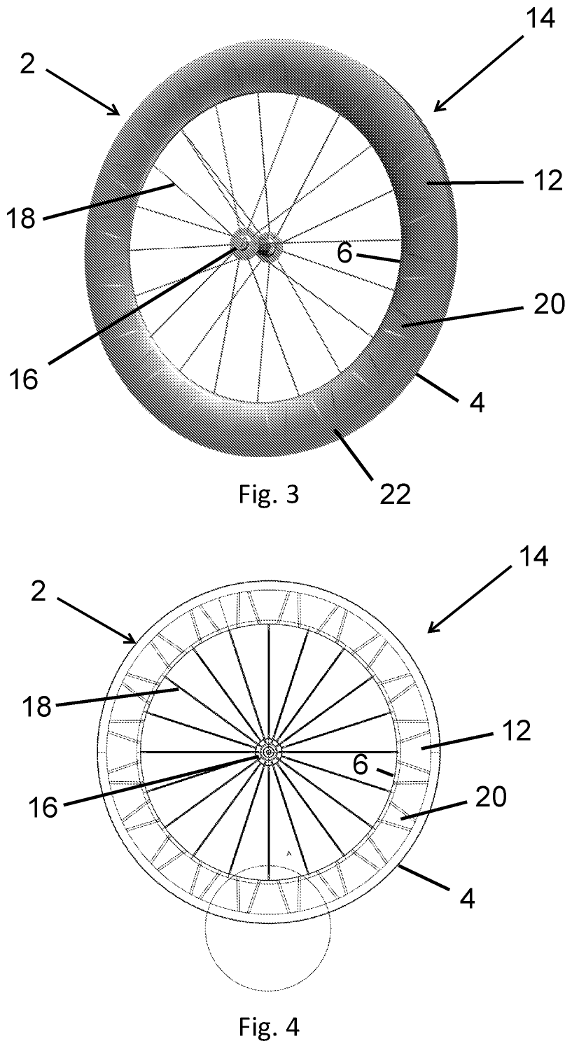

FIG. 3 is an isometric view of a first bicycle wheel according to an embodiment of the invention;

FIG. 4 is a side elevation of the first wheel;

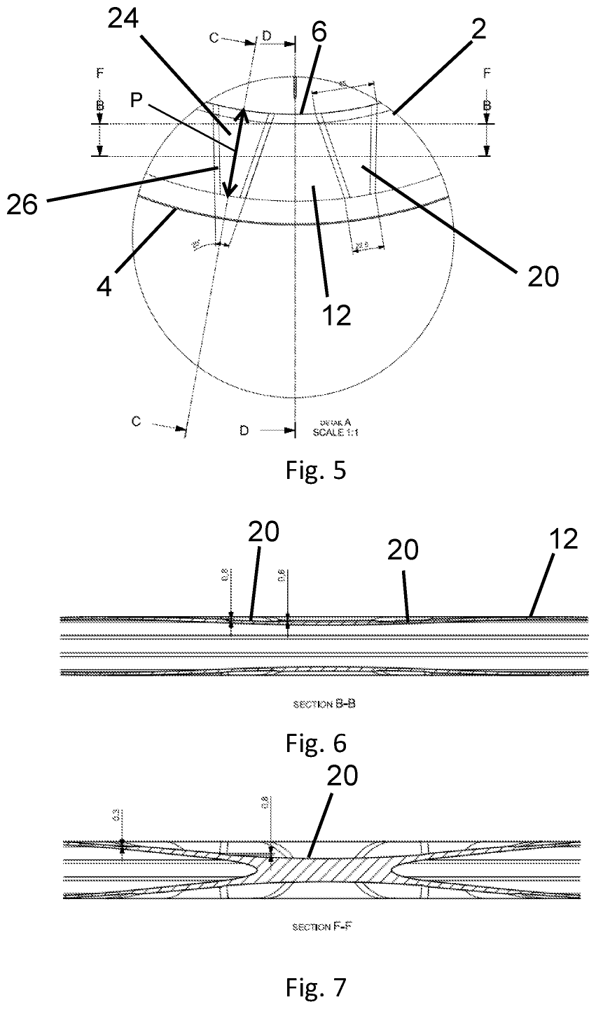

FIG. 5 is a side elevation at an enlarged scale showing a portion of the first wheel;

FIG. 6 is a section on line B-B of FIG. 5;

FIG. 7 is a section on line F-F of FIG. 5;

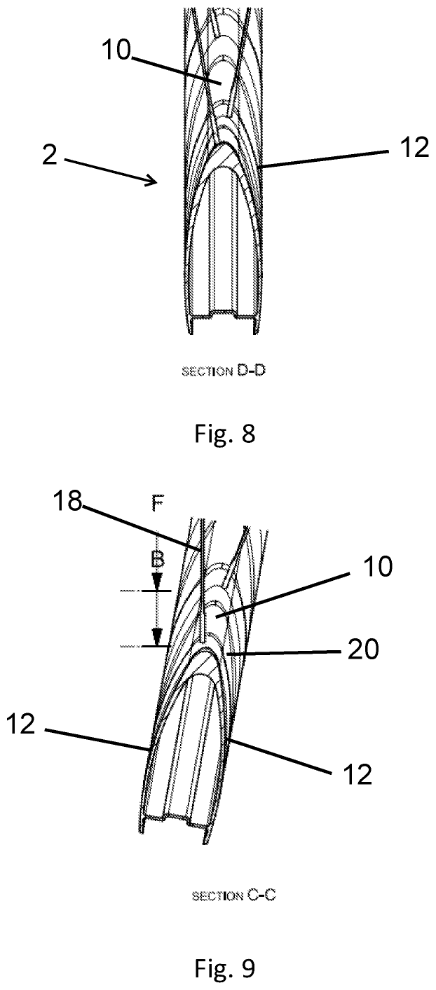

FIG. 8 is a section on line D-D of FIG. 5;

FIG. 9 is a section on line C-C of FIG. 5;

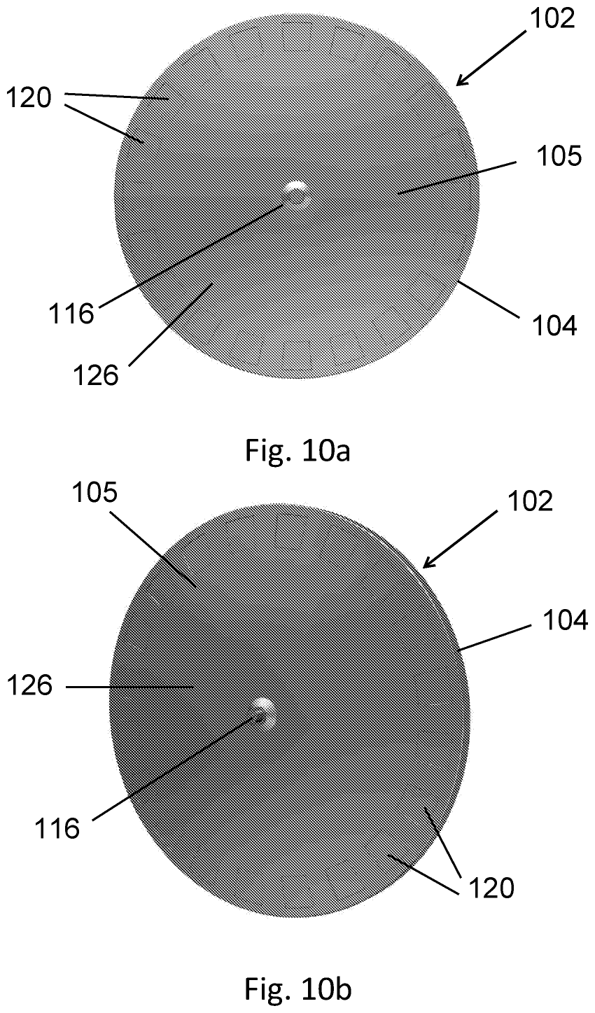

FIGS. 10a and 10b are a side elevation and an isometric view of a second bicycle wheel according to an embodiment of the invention; and

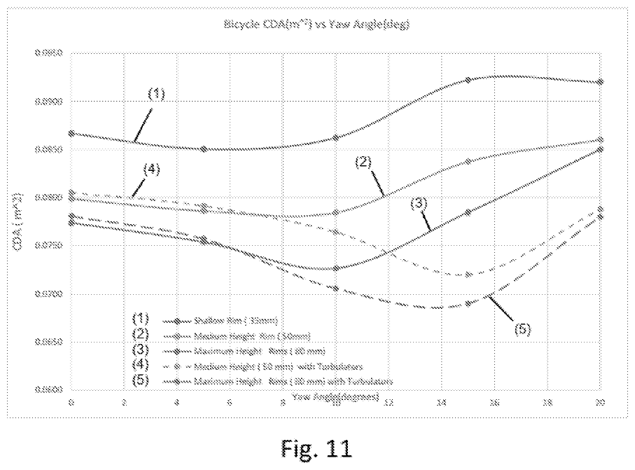

FIG. 11 is a graph showing the variation of aerodynamic drag with yaw angle for various bicycle wheels, including conventional wheels and wheels comprising embodiments of the invention.

FIGS. 1 and 2 are cross-sections through the wheel rims of first and second conventional wheel sets. The rims 2 of both wheel sets are designed to reduce aerodynamic drag and have U-V cross-sectional profiles, which taper from an outer circumferential portion 4 to an inner circumferential portion 6. The outer circumferential portion 4 comprises a mounting portion 8 for receiving a tyre (not shown), and in this case the mounting portion 8 comprises a pair of radial flanges for mounting a conventional cinch type tubed tyre. Alternatively, the mounting portion 8 may comprise a mounting surface (for example a U-shaped or V-shaped concave surface) for receiving a tubeless tyre. The inner circumferential portion 6 comprises a spoke face 10, which is connected by spokes or other connecting elements to a wheel axle or wheel hub (see FIG. 3).

The outer circumferential portion 4 and the inner circumferential portion 6 are connected by a pair of side portions 12, which extend radially between the inner circumferential portion 6 and the outer circumferential portion 4. In this embodiment the rim 2 is hollow and the side portions 12 comprise side walls. Alternatively, the rim 2 may be solid, in which case the side portions 12 may comprise side surfaces of the rim 2.

The wheel set shown in FIG. 1 is a mid-depth wheel set in which the rim of the front wheel has a width of 29 mm and a radial depth of 54 mm, while the rim of the rear wheel has a width of 28 mm and a radial depth of 63 mm. The wheel set shown in FIG. 2 is a deep wheel set in which the rim of the front wheel has a width of 29 mm and a radial depth of 71 mm, while the rim of the rear wheel has a width of 27.5 mm and a radial depth of 78 mm.

The aerodynamic shapes of the rims shown in FIGS. 1 and 2 are tuned to minimise aerodynamic drag and improve stability in windy conditions. However, there is a compromise between minimising aerodynamic drag and providing sufficient stability for the bicycle to be stable and rideable on windy days. One of the main causes of instability is the non-linear change in forces acting on the wheel when the air flow becomes separated, for example due to cross winds.

A bicycle wheel 14 according to an embodiment of the invention is shown in FIG. 3. In this embodiment the wheel 14 comprises an annular rim 2, a hub 16, which conventionally contains an axle, bearings and a hub shell, and a plurality of spokes 18 or other connecting elements that connect to the rim 2 to the hub 16. The tyre, which is mounted on the outer circumferential portion 4 of the rim 2, has been omitted from the drawing.

The rim 2 may have a cross-sectional profile that is similar to the U-V profiles of the conventional wheel sets shown in FIGS. 1 and 2. However, unlike the conventional wheel sets shown in FIGS. 1 and 2 which have smooth side portions 12 and a uniform cross-sectional profile, in the embodiment illustrated in FIG. 3 the side portions 12 and the inner circumferential portion 6 of the rim 2 include a plurality of pockets 20, which are recessed below the primary surface 22 of the side portions. Each of the pockets 20 thus extends across the inner circumferential portion 6 and then extends outwards across both side portions 12 of the rim 2. Alternatively, separate pockets 20 may be provided on each of the side portions 12, and optionally the pockets may be omitted from the inner circumferential portion 6 of the rim 2.

In the embodiment shown in FIG. 3 each side portion 12 of the rim 2 has twenty pockets 20, which are evenly spaced around the circumference of the rim. The rim 2 may alternatively include more or fewer pockets, for example a number N of pockets, where N is in the range 8-50, preferably 10-30, preferably 15-25.

Although the surface formations are described as recessed pockets 20, the undulating surface of the inner circumferential portion 6 and the side portions 12 can equally be described as comprising raised (or in relief) portions that extend outwards beyond a primary surface, where the primary surface corresponds to the base of the recessed pockets as described above. It is to be understood that the present claims are intended to cover such an embodiment, which is functionally equivalent to the invention as described above.

The wheel 14 illustrated in FIG. 3 is shown in more detail in FIGS. 4-9. As seen most clearly in FIG. 5, in this embodiment each pocket 20 extends outwards from the inner circumferential portion 6 of the rim 5 to approximately 80% of the radial depth of the rim 5. More generally, where the rim has a rim depth D measured radially between the inner circumferential portion and the outer circumferential portion, each pocket may extend radially for a pocket radial distance P of at least 0.4D, preferably at least 0.6D, preferably 0.8D. This optionally leaves an outer area 22 of the rim 5 with no pockets. This allows for mounting a tubed tyre. The outer area 22 may also optionally serve as a brake surface.

In this embodiment each pocket 20 comprises a base portion 24 and a pair of side walls 26 that extend between the base portion 24 and the primary surface 12. The side walls may optionally be inclined relative to the primary surface, for example at an angle in the range 5-30 degrees, preferably 8-20 degrees, preferably 10-15 degrees.

In this embodiment the pockets extend substantially radially across the side walls (i.e. in a substantially radial direction). Optionally, each side wall extends at an angle A relative to the radial direction, where the angle A is in the range 0-30 degrees, preferably 3-20 degrees, preferably 5-15 degrees. In the example illustrated in the drawings, the angle A is 10 degrees. Accordingly, the pair of side walls converge in a radially outward direction. In this example, the convergence angle is 20 degrees.

The pockets have a recess depth R that is measured in a direction perpendicular to the plane of the wheel, between the base portion of the recess and the primary surface of the rim 5. In some embodiments each pocket has a recess depth greater than 0.2 mm, preferably greater than 0.4 mm, preferably greater than 0.6 mm. Optionally, each pocket has a recess depth less than 4 mm, preferably less than 2 mm, preferably less than 1 mm.

Alternatively, as illustrated in FIGS. 10a and 10b, the wheel may comprise a disc wheel 102 in which the rim 105 extends continuously from the hub 116 to the outer circumferential portion 104. In that case, recessed pockets 120 similar to those described above may be provided in the side surfaces 126 of the disc wheel, preferably in an outer portion thereof.

Wheels according to the present invention have been tested in a wind tunnel for their aerodynamic performance as compared to conventional wheels with shallow rims, medium depth rims and deep rims. The results are illustrated in FIG. 11.

FIG. 11 is a graph showing the variation of aerodynamic drag with yaw angle for various bicycle wheels, including conventional wheels and wheels comprising embodiments of the invention. The lines represent the following wheels:
(1) Conventional non-aerodynamic wheel with shallow rim (rim depth 35 mm)
(2) Conventional aerodynamic wheel with medium height rim (50 mm)
(3) Conventional aerodynamic wheel with maximum height rim (80 mm)
(4) Embodiment: aerodynamic wheel with medium height rim (50 mm) and turbulator pockets
(5) Embodiment: aerodynamic wheel with maximum height rim (80 mm) and turbulator pockets.

All wheels are prone to flow separation. A shallow rim will have separated flow regardless of the wind angle. By increasing the rim depth flow separation can be reduced or avoided and the wheel can have a sail effect in a cross wind. The rim depth and shape both determine when the air flow over rim separates. As illustrated in FIG. 11 the conventional 35 mm rim (1) starts to control the air flow in a cross wind and there is a small drag reduction before flow separation starts at around 5 degrees. Similarly, the conventional aerodynamic wheel (2) with a medium height rim depth of 50 mm delays separation to around 8 degrees and the conventional aerodynamic wheel (3) with a maximum height rim depth of 80 mm separates slightly later at 10 degrees.

When testing wheels in a wind tunnel, the drag reduces in a cross wind until the stall angle is reached. It is desirable for drag reduction and for steering stability to delay the stall angle for as long as possible. In general, a deeper and/or more cambered rim helps to increase the stall angle. However, there are practical considerations to rim depth. Deep rims are too heavy and exhibit poor acceleration. Similarly, deep rims produce a high side force and when the wind does separate it can create large steering fluctuations that are disconcerting and dangerous (possibly leading to loss of control of the bike).

It is therefore desirable to reduce flow separation by turbulating the flow on the rim. We have attempted to add alternative features in a bid to delay flow separation. Unfortunately, none of these have been successful. They tend to add surface drag but do not help to the delay separation.

The present invention is based on the idea of adding larger turbulator pockets, which provide vortex shedding at a much lower frequency and present a smooth transition that doesn't add too much surface friction but subtly turbulates the air flow.

The dotted lines (4) and (5) show how the turbulator pockets can significantly delay flow separation and therefore continue to reduce drag at high yaw angles.

A prototype wheel has been made with sections of the rim surface pocketed and blended as shown above to provide turbulator pockets. The interruption in the surface and the edge presented to the air flow as the wheel rotates appear to aid flow attachment as indicated by the dotted lines (4) and (5) in the graph for the medium and deep rims. Whilst there is a small increase in drag at low yaw angles there is significant reduction in drag at higher yaw angles with flow separation being delayed by as much as 5 degrees.

Various modifications can be made to the invention to fully optimise the concept and to provide a better understanding of the performance of the key variables, which include:
1) Frequency of the pockets
2) Depth of the pockets
3) Length of the pockets
4) Edge angle relative to the radial centreline
5) Shape and symmetry of the pockets.
6) Radius of edges (which needs to be at least 1 mm to suit carbon manufacturing requirements)

The configuration of the turbulator pockets will also vary depending on the depth of the rim. Its most likely that a more aggressive turbulator pocket will be needed on shallower rims where flow separation occurs earlier. It possible that there could be benefit in adding turbulators to a disc wheel close to the tire. Accordingly, the present patent application is intended to cover all types of wheels regardless of rim depth (greater than 30 mm).

1. A bicycle wheel comprising an annular rim having an inner circumferential portion, an outer circumferential portion and a pair of side portions that extend between the inner circumferential portion and the outer circumferential portion, wherein each side portion comprises a primary surface and a plurality of pockets that are recessed below the primary surface.

2. A bicycle wheel according to claim 1, wherein each pocket has an area S of at least 0.25 cm².

3. A bicycle when according to claim 1, wherein each pocket has an area S of less than 50 cm².

4. A bicycle wheel according to claim 1, wherein each pocket has a recess depth R greater than 0.1 mm.

5. A bicycle wheel according to claim 1, wherein each pocket has a recess depth R less than 4 mm, preferably less than 2 mm, preferably less than 1 mm.

6. A bicycle wheel according to claim 1, wherein each pocket comprises a base portion and at least one side wall that extends between the base portion and the primary surface.

7. A bicycle wheel according to claim 6, wherein the at least one side wall is inclined relative to the primary surface at an angle in the range 5-30 degrees.

8. A bicycle wheel according to claim 1, wherein the pockets extend substantially radially.

9. A bicycle wheel according to claim 8, wherein each pocket includes a base portion and a pair of side walls that extend between the base portion and the primary surface, wherein each side wall extends at an angle A relative to a radial direction, where the angle A is in the range 0-30 degrees.

10. A bicycle wheel according to claim 9, wherein said pair of side walls converge in a radially outward direction.

11. A bicycle wheel according to claim 1, wherein each of the pockets extends across the inner circumferential portion and then extends outwards across the side portions of the rim.

12. A bicycle wheel according to claim 1, wherein the rim has a rim depth D measured radially between the inner circumferential portion and the outer circumferential portion, and each pocket extends radially for a pocket radial distance P, where P has a value of at least 0.4D.

13. A bicycle wheel according to claim 1, wherein each side portion includes a number N of pockets spaced circumferentially around the rim, where the number N is in the range 8-50.

14. A bicycle wheel according to claim 1, wherein each side portion includes a plurality of pockets spaced circumferentially around the rim, and wherein each pocket is spaced from an adjacent pocket by a spacing angle B in the range 7-45 degrees.

15. A bicycle wheel according to claim 1, wherein the rim has a rim depth D measured radially between the inner circumferential portion and the outer circumferential portion, wherein the rim depth D is in the range 30-200 mm.

16. A bicycle wheel according to claim 1, wherein the rim has a cross-sectional profile that is substantially U shaped, or substantially V shaped, or U/V shaped.

17. A bicycle wheel according to claim 1, further comprising a hub and a plurality of connecting elements that connect to the annular rim to the hub.

18. A bicycle wheel according to claim 1, wherein the inner circumferential portion contacts an axle of the wheel, whereby the bicycle wheel comprises a solid disc.

19. A bicycle wheel comprising a disc having an axis of rotation, an outer circumferential portion and a pair of side portions that extend between the axis of rotation and the outer circumferential portion, wherein each side portion comprises a primary surface and a plurality of pockets that are recessed below the primary surface.

20. A bicycle wheel according to claim 19, wherein each pocket has an area S of at least 1 cm².

21. A bicycle when according to claim 19, wherein each pocket has an area S of less than 50 cm².

22. A bicycle wheel according to claim 19, wherein each pocket has a recess depth R greater than 0.2 mm.

23. A bicycle wheel according to claim 19, wherein each pocket has a recess depth R less than 4 mm.

24. A bicycle wheel according to claim 19, wherein each pocket comprises a base portion and at least one side wall that extends between the base portion and the primary surface.

25. A bicycle wheel according to claim 24, wherein the at least one side wall is inclined relative to the primary surface at an angle in the range 5-30 degrees.

26. A bicycle wheel according to claim 19, wherein the pockets extend substantially radially.

27. A bicycle wheel according to claim 26, wherein each pocket includes a base portion and a pair of side walls that extend between the base portion and the primary surface, wherein each side wall extends at an angle A relative to a radial direction, where the angle A is in the range 0-30 degrees.

28. A bicycle wheel according to claim 27, wherein said pair of side walls converge in a radially outward direction.

29. A bicycle wheel according to claim 19, wherein each side portion includes a number N of pockets spaced circumferentially around the rim, where the number N is in the range 8-50.

30. A bicycle wheel according to claim 19, wherein each side portion includes a plurality of pockets spaced circumferentially around the rim, and wherein each pocket is spaced from an adjacent pocket by a spacing angle B in the range 7-45 degrees.

31. A bicycle wheel according to claim 19, wherein the wheel has a wheel radius W measured radially between the axis of rotation and the outer circumferential portion, and each pocket is located in a radially outer part of the wheel at a distance X from the axis of rotation, where X is at least 0.4W.
